(19) United States
(12) Patent Application Publication
(10) Pub. No.: US 2008/0268169 A1
(43) Pub. Date: Oct. 30, 2008

(54) Cationically Curable Coating Compositions

(75) Inventors: Stephen Stuart Standing, Orpington Kent (GB); Mark William Walkling, Kent (GB); Shaun Lawrence Herlihy, Kent (GB); James Robert Tucker, Catford London (GB)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: SUN CHEMICAL CORPORATION, Parsippany, NJ (US)

(21) Appl. No.: 11/720,238

(22) PCT Filed: Nov. 23, 2005
(86) PCT No.: PCT/US05/42783

§ 371 Date: Feb. 22, 2008

(30) Foreign Application Priority Data
Dec. 1, 2004 (GB) 0426380.2

(51) Int. Cl. C08J 7/18; C08J 3/28

(52) U.S. Cl. 427/553; 522/31

(57) ABSTRACT

We have found that the use of a multifunctional oxetane containing two or more oxetane groups as the, or part of the, polymerisable component of a cationically initiated energy-curable coating composition with a thioxanthonium photoinitiator gives a coating composition which is useful for a variety of printing processes, including flexographic printing.

The present invention relates to novel coating compositions, such as printing inks, varnishes and adhesives, which can be cured by energy, particularly radiation, such as ultraviolet radiation, using a cationic photoinitiator, and which are especially suitable for flexographic printing.

Since the early 1990s, ultraviolet (UV) curing flexographic (flexo) ink technology has been used for printing labels, folding cartons and other packaging substrates. Compared with traditional solvent based flexo inks, UV flexo inks contain no volatile content and are often preferred on environmental and safety grounds. Solvent based inks are flammable and produce unpleasant odours in the printing environment. Water based flexo inks are free from organic solvents and so are considered a safe option from the point of workplace safety, but their use results in water waste that is difficult and costly to dispose of, and they require more energy for drying. In addition, water based inks do not adhere well to a wide range of substrates. Finally, UV flexo has advantages of producing prints with high chemical resistance, high water resistance, and good flexibility.

UV flexo inks are predominantly based on free radical acrylate chemistry, but cationic technology has been developed as an alternative. Compared with free radical curing UV inks, cationic curing inks can offer superior adhesion across a wide range of substrates, superior chemical resistance, excellent post-cure, and no need for use in an inert, e.g. nitrogen, atmosphere, as is the case for some radical curing UV ink systems.

The currently available cationically curable UV flexo inks suffer from the following disadvantages in food packaging applications. Typical sulphonium salt photoinitiators used give breakdown products such as diphenyl sulphide, which has a strong odour on cure and can migrate into the contents of a package, and benzene, which is a carcinogen. Alternative cationic photoinitiators such as iodonium salts are also highly odorous on cure. Antimony-based photoinitiators are not acceptable because of their heavy metal content.

Current cationic UV flexo inks have a printing press speed limitation. Press speeds of greater than 100 m/min are rare. This is significantly lower than press speeds achievable with alternative flexographic printing ink technologies (150-200 m/min).

There is therefore a need for improved cationic curing UV flexo inks, which overcome the safety problems associated with potential migration of harmful breakdown products in food packaging applications, and which cure much faster than existing products.

We have now discovered that these aims may be achieved by the combined use of a multifunctional oxetane monomer or oligomer (containing two or more oxetane groups) with a thioxanthonium-type cationic photoinitiator.

A paper by Antoine Carroy, published as part of RadTech 2004 Technical Proceedings, and entitled “New developments in cationic curing flexo inks” refers to a thioxanthonium photoinitiator, 10-biphenyl-4-yl-2-isopropyl-9-oxo-9H-thioxanthen-10-ium hexafluorophosphate, photoinitiator, and also mentions oxetane derivatives as suitable reactive monomers. However, only the mono-oxetane, 3-ethyl-3-hydroxymethyl-oxetane (referred to in the paper as EHMO) is used in the formulations described. We have found that multi-functional oxetanes, such as the dioxetanes, give dramatically improved cure speed.

JP08143806, published on 4 Jun. 1996, describes printing inks curable by UV and containing mono- to tetra-functional oxetanes and cationic photoinitiators. The compositions are said to be suitable for use in various printing methods, including offset lithography, letterpress, screen, or gravure.

The present invention consists in a cationically curable coating composition comprising:

(a) a cationically polymerisable component comprising at least one compound having at least two polymerisable oxetane groups and
(b) an initiator comprising a thioxanthonium salt.

A variety of oxetane compounds is available for use as the, or a component of the, cationically polymerisable component (a). For example, one such class of compounds are those compounds of formula (I):

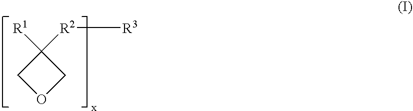

in which:
R¹ represents a hydrogen atom, a C₁-C₆ alkyl group, an aryl group or an aralkyl group;
R² represents a direct bond or a C₁-C₆ alkylene group;
R³ represents the residue of a polyol; and
x is a number from 2 to 6.

In the compounds of formula (I), x is more preferably from 2 to 4, still more preferably x is 2.

A further class of oxetane compounds which may be the, or a component of the polymerisable component (a), are those compounds of formula (II):

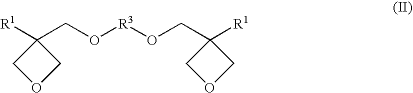

in which:
R¹ represents a hydrogen atom, a C₁-C₆ alkyl group, an aryl group or an aralkyl group, and the two groups R¹ may be the same as or different from each other; and
R³ represents a C₁-C₁₂ alkylene group, a C₂-C₁₂ alkenylene group, a poly(alkyleneoxy) group, a carbonyl group, a C₂-C₁₂ alkylene group in which a methylene group is replaced by a carbonyl group, an aryl group.

In the compounds of formula (II), we prefer that R³ should represent a C₁-C₆ alkylene group.

A further class of oxetane compounds which may be the, or a component of the, polymerisable component (a) are those compounds of formula (III):

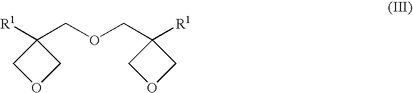

in which R¹ represents a hydrogen atom, a C₁-C₆ alkyl group, an aryl group or an aralkyl group, and the two groups R¹ may be the same as or different from each other.

A particularly preferred example of the compounds of formula (III) is bis[(1-ethyl-3-oxetanyl)methyl]ether.

A further class of oxetane compounds which may be the, or a component of the polymerisable component (a), are those compounds formula (IV):

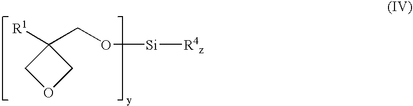

R¹ represents a hydrogen atom, a C₁-C₆ alkyl group, an aryl group or an aralkyl group;
R⁴ represents a group of formula —O—R⁵ or a group R⁶;
R⁵ represents a C₁-C₂₀ alkyl group, a C₂-C₂₀ alkenyl group, an aryl group, an aralkyl group, a polyalkylene oxide group or a poly(lactone) group;
R⁶ represents a C₁-C₂₀ alkyl group, an aryl group or an aralkyl group;
y is a number greater than 1 and no greater than 4; and
(y+z)=4.

Particularly preferred compounds of formula (IV) include the compounds of formula (V):

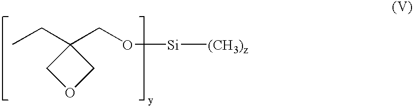

where y is a number of at least 2 and no greater than 4 and z is (4-y).

Compounds of formula (IV) and (V) are disclosed in GB 2393444, the disclosure of which is incorporated herein by reference.

Other examples of oxetane compounds which may be used in the present invention include compounds of formula (IX):

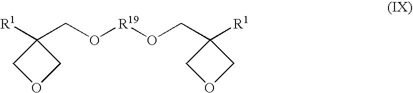

in which R¹⁹ represents a group of formula (X), (XI), or (XII) or a carbonyl group:

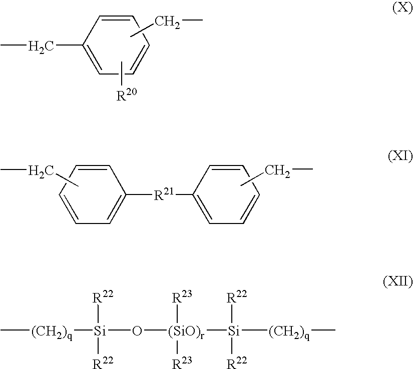

in which:
R²⁰ represents a C₁-C₄ alkyl group (e.g. methyl, ethyl, propyl or butyl), a C₁-C₄ alkoxy group (e.g. methoxy, ethoxy, propoxy or butoxy), a halogen atom (e.g. chlorine or bromine), a nitro group, a cyano group, a mercapto group, a C₁-C₄ alkylthio group, a carboxy group, a C₂-C₅ alkoxycarbonyl group or a carbamoyl group;
R²¹ represents an oxygen atom, a sulphur atom, a methylene group, or a group —NH—, —SO—, —SO₂—, —C(CF₃)₂— or —C(CH₃)₂—;
q is a number from 1 to 6, preferably 3;
R²² represents a C₁-C₄ alkyl group (e.g. methyl, ethyl, propyl or butyl) or an aryl group (e.g. phenyl);
r is a number from 0 to 2000; and
R²³ represents a C₁-C₄ alkyl group (e.g. methyl, ethyl, propyl or butyl), an aryl group (e.g. phenyl) or a group of formula (XIII):

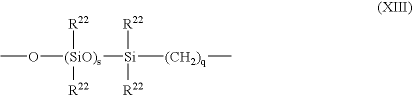

in which R²² and q are as defined above and s is a number from 0 to 100.

Another example of a multifunctional oxetane is PNOX-1009, available from Taogosei Co. Ltd.

An example of a class of thioxanthonium salts (b) are those compounds of formula (VI):

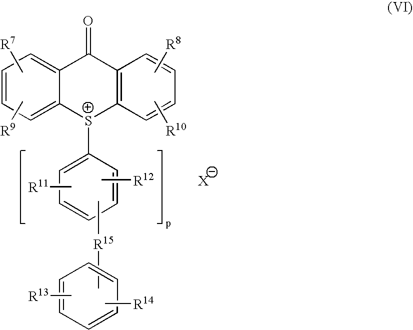

in which:
R⁷, R⁸, R⁹ and R¹⁰ are individually the same or different and each represents a hydrogen atom; an alkyl group having from 1 to 20 carbon atoms, an alkoxy group having from 1 to 20 carbon atoms, an alkenyl group having from 2 to 20 carbon atoms, a halogen atom, a nitrile group, a hydroxyl group, an aryl group having from 6 to 10 carbon atoms, an aralkyl group having from 7 to 13 carbon atoms, an aryloxy group having from 6 to 10 carbon atoms, an aralkyloxy group having from 7 to 13 carbon atoms, an arylalkenyl group having from 8 to 12 carbon atoms, a cycloalkyl group having from 3 to 8 carbon atoms, a carboxy group, a carboxyalkoxy group having from 2 to 7 carbon atoms, an alkoxycarbonyl group having from 2 to 7 carbon atoms, an aryloxycarbonyl group having from 7 to 13 carbon atoms, an alkylcarbonyloxy group having from 2 to 7 carbon atoms, an alkanesulphonyl group having from 1 to 6 carbon atoms, an arenesulphonyl group having from 6 to 10 carbon atoms, an alkanoyl group having from 1 to 6 carbon atoms or an arylcarbonyl group having from 7 to 11 carbon atoms;
R¹¹, R¹², R¹³ and R¹⁴ are individually the same or different and each represents a hydrogen atom, a hydroxy group, or an alkyl group having from 1 to 4 carbon atoms;
or R¹² and R¹⁴ are joined to form a fused ring system with the benzene rings to which they are attached;
R¹⁵ represents a direct bond, an oxygen atom or a methylene group;
p is 0 or 1; and
X⁻ represents an anion;
and esters thereof.

These compounds are disclosed in WO 03/072567, the disclosure of which is incorporated herein by reference.

A further example of a class of thioxanthonium salts (b) are those compounds of formula (VII):

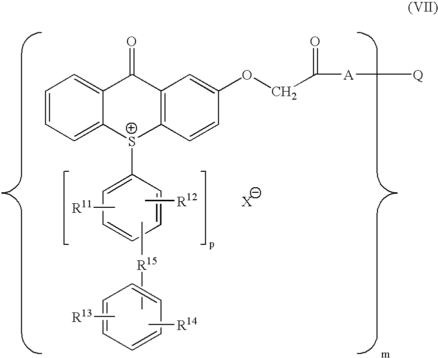

in which:
A represents a direct bond or a group of formula —[O(CHR¹⁶CHR¹⁷)ₐ]_{b}—, —[O(CH₂)_{c}CO]_{b}—, or —[O(CH₂)_{c}CO]_{(b-1)}—[O(CHR¹⁶CHR¹⁷)ₐ]—, where:
one of R¹⁶ and R¹⁷ represents a hydrogen atom and the other represents a hydrogen atom or a methyl group;
a is a number from 1 to 2;
b is a number from 1 to 10;
c is a number from 4 to 5;
Q is a residue of a polyol having from 2 to 6 hydroxy groups;
m is a number greater than 1 but no greater than the number of available hydroxyl groups in Q;
R¹¹, R¹², R¹³ and R¹⁴ are individually the same or different and each represents a hydrogen atom, a hydroxy group, or an alkyl group having from 1 to 4 carbon atoms;
or R¹² and R¹⁴ are joined to form a fused ring system with the benzene rings to which they are attached;
R¹⁵ represents a direct bond, an oxygen atom or a methylene group;
p is 0 or 1; and
X⁻ represents an anion;
or an ester thereof.

These compounds are disclosed in WO 03/072568, the disclosure of which is incorporated herein by reference.

A further example of a class of thioxanthonium salts (b) are those compounds of formula (VIII):

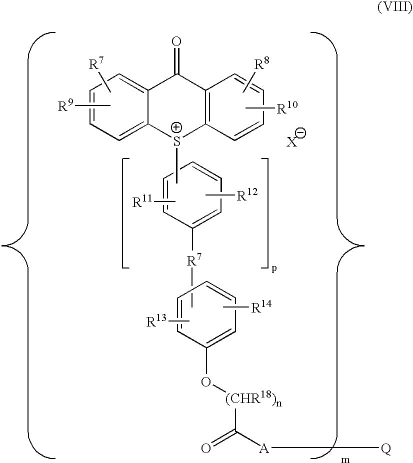

in which:
R⁷, R⁸, R⁹ and R¹⁰ are individually the same or different and each represents a hydrogen atom; an alkyl group having from 1 to 20 carbon atoms, an alkoxy group having from 1 to 20 carbon atoms, an alkenyl group having from 2 to 20 carbon atoms, a halogen atom, a nitrite group, a hydroxyl group, an aryl group having from 6 to 10 carbon atoms, an aralkyl group having from 7 to 13 carbon atoms, an aryloxy group having from 6 to 10 carbon atoms, an aralkyloxy group having from 7 to 13 carbon atoms, an arylalkenyl group having from 8 to 12 carbon atoms, a cycloalkyl group having from 3 to 8 carbon atoms, a carboxy group, a carboxyalkoxy group having from 2 to 7 carbon atoms, an alkoxycarbonyl group having from 2 to 7 carbon atoms, an aryloxycarbonyl group having from 7 to 13 carbon atoms, an alkylcarbonyloxy group having from 2 to 7 carbon atoms, an alkanesulphonyl group having from 1 to 6 carbon atoms, an arenesulphonyl group having from 6 to 10 carbon atoms, an alkanoyl group having from 1 to 6 carbon atoms or an arylcarbonyl group having from 7 to 11 carbon atoms;
R¹¹, R¹², R¹³ and R¹⁴ are individually the same or different and each represents a hydrogen atom, a hydroxy group, or an alkyl group having from 1 to 4 carbon atoms;
or R¹² and R¹⁴ are joined to form a fused ring system with the benzene rings to which they are attached;
R¹⁵ represents a direct bond, an oxygen atom or a methylene group;
p is 0 or 1;
X⁻ represents an anion;
A represents a direct bond or a group of formula —[O(CHR¹⁶CHR¹⁷)ₐ]_{b}—, —[O(CH₂)_{c}CO]_{b}—, or —[O(CH₂)_{c}CO]_{(b-1)}—[O(CHR¹⁶CHR¹⁷)ₐ]—, where:
one of R¹⁶ and R¹⁷ represents a hydrogen atom and the other represents a hydrogen atom or a methyl group;
a is a number from 1 to 2;
b is a number from 1 to 10;
c is a number from 4 to 5;
Q is a residue of a polyol having from 2 to 6 hydroxy groups;
m is a number greater than 1 but no greater than the number of available hydroxyl groups in Q;
n is a number from 1 to 12; and
R¹⁸ represents a hydrogen atom, a methyl group or an ethyl group, and, when n is greater than 1, the groups or atoms represented by R¹² may be the same as or different from each other;
or an ester thereof.

These compounds are disclosed in WO 2004/055000, the disclosure of which is incorporated herein by reference.

Where R¹ represents an alkyl group, this may be a straight or branched chain alkyl group having from 1 to 6 carbon atoms, and examples include the methyl, ethyl, propyl, isopropyl, butyl, isobutyl, t-butyl, pentyl, isopentyl, neopentyl, 2-methylbutyl, 1-ethylpropyl, 4-methylpentyl, 3-methylpentyl, 2-methylpentyl, 1-methylpentyl, 3,3-dimethylbutyl, 2,2-dimethylbutyl, 1,1-dimethylbutyl, 1,2-dimethylbutyl, 1,3-dimethylbutyl, 2,3-dimethylbutyl, 2-ethylbutyl, hexyl and isohexyl groups.

Where R⁵, R⁶, R⁷, R⁸, R⁹ or R¹⁰ represents an alkyl group having from 1 to 20, preferably from 1 to 10, more preferably from 1 to 6 and most preferably from 1 to 3, carbon atoms, this may be a straight or branched chain group, and examples of such groups include the methyl, ethyl, propyl, isopropyl, butyl, isobutyl, t-butyl, pentyl, isopentyl, neopentyl, 2-methylbutyl, 1-ethylpropyl, 4-methylpentyl, 3-methylpentyl, 2-methylpentyl, 1-methylpentyl, 3,3-dimethylbutyl, 2,2-dimethylbutyl, 1,1-dimethylbutyl, 1,2-dimethylbutyl, 1,3-dimethylbutyl, 2,3-dimethylbutyl, 2-ethylbutyl, hexyl, isohexyl, heptyl, octyl, nonyl, decyl, dodecyl, tridecyl, pentadecyl, octadecyl, nonadecyl and icosyl groups, but preferably the methyl, ethyl, propyl, isopropyl and t-butyl groups, and most preferably the ethyl or isopropyl group.

Where R⁷, R⁸, R⁹ or R¹⁰ represents an alkoxy group having from 1 to 20, preferably from 1 to 10, more preferably from 1 to 6 and most preferably from 1 to 3, carbon atoms, this may be a straight or branched chain group, and examples of such groups include the methoxy, ethoxy, propoxy, isopropoxy, butoxy, isobutoxy, t-butoxy, pentyloxy, isopentyloxy, neopentyloxy, 2-methylbutoxy, 1-ethylpropoxy, 4-methylpentyloxy, 3-methylpentyloxy, 2-methylpentyloxy, 1-methylpentyloxy, 3,3-dimethylbutoxy, 2,2-dimethylbutoxy, 1,1-dimethylbutoxy, 1,2-dimethylbutoxy, 1,3-dimethylbutoxy, 2,3-dimethylbutoxy, 2-ethylbutoxy, hexyloxy, isohexyloxy, heptyloxy, 2-ethylhexyloxy, octyloxy, nonyloxy, decyloxy, dodecyloxy, tridecyloxy, pentadecyloxy, octadecyloxy, nonadecyloxy and icosyloxy groups, but preferably the methoxy, ethoxy, t-butoxy and 2-ethylhexyloxy groups, and most preferably the 2-ethylhexyloxy group.

Where R⁵, R⁷, R⁸, R⁹ or R¹⁰ represents an alkenyl group having from 2 to 20, preferably from 2 to 10, more preferably from 2 to 6 and most preferably from 2 to 4, carbon atoms, this may be a straight or branched chain group, and examples of such groups include the vinyl, 1-propenyl, allyl, isopropenyl, methallyl, butenyl, pentenyl, hexenyl, heptenyl, octenyl, nonenyl, decenyl, dodecenyl, tridecenyl, pentadecenyl, octadecenyl, nonadecenyl and icosenyl groups, but preferably the allyl, methallyl and butenyl groups, and most preferably the allyl group.

Where R⁷, R⁸, R⁹ or R¹⁰ represents a halogen atom, this may be, for example, a fluorine, chlorine, bromine or iodine atom, preferably a chlorine atom.

Where R¹, R⁵, R⁶, R⁷, R⁸, R⁹ or R¹⁰ represents an aryl group, this has from 6 to 10 carbon atoms in one or more aromatic carbocyclic rings (which, if there are more than one, may be fused together). Such a group may be substituted or unsubstituted, and, if substituted, the substituent(s) is preferably an alkyl or alkoxy group (as defined above), or an alkoxycarbonyl group (as defined below). Preferred aryl groups are the phenyl and naphthyl (1- or 2-) groups, the phenyl group being most preferred.

Where R⁷, R⁸, R⁹ or R¹⁰ represents an aryloxy group, this may be any of the aryl groups above bonded to an oxygen atom, and examples include the phenoxy and naphthyloxy groups.

Where R¹, R⁵, R⁶, R⁷, R⁸, R⁹ or R¹¹ represents an aralkyl group, this is an alkyl group having from 1 to 4 carbon atoms which is substituted by one or two aryl groups as defined and exemplified above. Examples of such aralkyl groups include the benzyl, α-phenylethyl, β-phenylethyl, 3-phenylpropyl, 4-phenylbutyl, diphenylmethyl, 1-naphthylmethyl and 2-naphthylmethyl groups, of which the benzyl group is preferred.

Where R⁷, R⁸, R⁹ or R¹¹ represents an aralkyloxy group, this may be any of the aralkyl groups above bonded to an oxygen atom, and examples include the benzyloxy, α-phenylethoxy, β-phenylethoxy, 3-phenylpropoxy, 4-phenylbutoxy, diphenylmethoxy, 1-naphthylmethoxy and 2-naphthylmethoxy groups, of which the benzyloxy group is preferred.

Where R⁷, R⁸, R⁹ or R¹⁰ represents an arylalkenyl group having from 8 to 12 carbon atoms, the aryl and alkenyl parts of this group may be as defined and exemplified above for the respective component parts. Specific examples of such groups are the styryl and cinnamyl groups.

Where R⁷, R⁸, R⁹ or R¹⁰ represents a cycloalkyl group having from 3 to 8 carbon atoms, this may be, for example, the cyclopropyl, cyclobutyl, cyclopentyl, cyclohexyl, cycloheptyl or cyclooctyl group.

Where R⁷, R⁸, R⁹ or R¹⁰ represents a carboxyalkoxy group, this may be any of the alkoxy groups having from 1 to 6 carbon atoms described above which is substituted by a carboxy group. Preferred examples include the carboxymethoxy, 2-carboxyethoxy and 4-carboxybutoxy groups, of which the carboxymethoxy group is preferred.

Where R⁷, R⁸, R⁹ or R¹⁰ represents an alkoxycarbonyl group, this has from 1 to 6 carbon atoms in the alkoxy part, and thus a total of from 2 to 7 carbon atoms. It may be a straight or branched chain group, and examples of such groups include the methoxycarbonyl, ethoxycarbonyl, propoxycarbonyl, isopropoxycarbonyl, butoxycarbonyl, isobutoxycarbonyl, t-butoxycarbonyl, pentyloxycarbonyl, isopentyloxyvcarbonyl, neopentyloxycarbonyl, 2-methylbutoxycarbonyl, 1-ethylpropoxycarbonyl, 4-methylpentyloxycarbonyl, 3-methylpentyloxycarbonyl, 2-methylpentyloxycarbonyl, 1-methylpentyloxycarbonyl, 3,3-dimethylbutoxycarbonyl, 2,2-dimethylbutoxycarbonyl, 1,1-dimethylbutoxycarbonyl, 1,2-dimethylbutoxycarbonyl, 1,3-dimethylbutoxycarbonyl, 2,3-dimethylbutoxycarbonyl, 2-ethylbutoxycarbonyl, hexyloxycarbonyl and isohexyloxycarbonyl groups, but preferably the methoxycarbonyl, ethoxycarbonyl and t-butoxycarbonyl groups, and most preferably the methoxycarbonyl or ethoxycarbonyl group.

Where R⁷, R⁸, R⁹ or R¹⁰ represents an aryloxycarbonyl group having from 7 to 13 carbon atoms, the aryl part of this may be any of the aryl groups defined and exemplified above. Specific examples of such groups include the phenoxycarbonyl and naphthyloxycarbonyl groups.

Where R⁷, R⁸, R⁹ or R¹⁰ represents an alkylcarbonyloxy group having from 2 to 7 carbon atoms, this may be any of the alkoxycarbonyl groups defined and exemplified above bonded to an oxygen atom.

Where R⁷, R⁸, R⁹ or R¹⁰ represents an alkanesulphonyl group, this has from 1 to 6 carbon atoms and is a straight or branched chain group. Examples of such groups include the methanesulphonyl, ethanesulphonyl, propanesulphonyl, isopropanesulphonyl, butanesulphonyl, isobutanesulphonyl, t-butanesulphonyl, pentanesulphonyl and hexanesulphonyl groups, of which the methanesulphonyl group is preferred.

Where R⁷, R⁸, R⁹ or R¹⁰ represents an arenesulphonyl group, the aryl part may be as defined and exemplified above, and examples include the benzenesulphonyl and p-toluenesulphonyl groups.

Where R⁷, R⁸, R⁹ or R¹⁰ represents an alkanoyl group having from 1 to 6 carbon atoms, and preferably from 1 to 4 carbon atoms, this may be a straight or branched chain group, and examples include the formyl, acetyl, propionyl, butyryl, isobutyryl, pivaloyl, valeryl, isovaleryl, and hexanoyl groups, of which the acetyl group is most preferred;

Where R⁷, R⁸, R⁹ or R¹¹ represents an arylcarbonyl group, the aryl part has from 6 to 10, more preferably 6 or 10, and most preferably 6, ring carbon atoms and is a carbocyclic group, which is unsubstituted or has from 1 to 5, preferably from 1 to 3 substituents, as defined and exemplified above. The preferred groups are the benzoyl and naphthoyl groups.

We particularly prefer those compounds of formula (I) in which R⁷, R⁸, R⁹ and R¹⁰ are individually the same or different and each represents a hydrogen atom, an alkyl group having from 1 to 10 carbon atoms, an alkoxy group having from 1 to 10 carbon atoms, a halogen atom, or a cycloalkyl group having from 3 to 8 carbon atoms, more especially those in which two or three of R⁷, R⁸, R⁹ and R¹¹ represent hydrogen atoms, and most preferably those in which one or two of R⁷, R⁸, R⁹ and R¹⁰ represents an ethyl or isopropyl group. The most preferred compounds are those in which one or two of R⁷, R⁸, R⁹ and R¹¹ represent ethyl groups or in which one of R⁷, R⁸, R⁹ and R¹⁰ represents an isopropyl group and the others represent hydrogen atoms.

Where R¹¹, R¹², R¹³ or R¹⁴ represents an alkyl group, this may be a straight or branched chain alkyl group having from 1 to 4 carbon atoms, and examples include the methyl, ethyl, propyl, isopropyl, butyl, isobutyl and t-butyl groups, of which the methyl group is preferred.

We prefer those compounds of formula (I) in which two, three or four of R¹¹, R¹², R¹³ and R¹⁴ represent hydrogen atoms, and especially those in which all of R¹¹, R¹², R¹³ and R¹⁴ represent hydrogen atoms.

When R¹² and R¹⁴, together with the benzene rings to which they are attached, form a fused ring system, this may be, for example, a biphenylene, fluorene or phenanthrene system, preferably fluorene.

R¹⁵ may be a direct bond (so that the two groups joined by R¹⁵ together form a biphenylyl group), an oxygen atom (so that the two groups joined by R¹⁵ together form a phenoxyphenyl group), or a methylene group (so that the two groups joined by R¹⁵ together form a benzylphenyl group).

In the compounds of the present invention, we prefer that A should represent a group of formula —[O(CHR¹⁶CHR¹⁷)ₐ]_{b}— where a is an integer from 1 to 2, and b is as defined above, more preferably a group of formula —[OCH₂CH₂]_{b}—, —[OCH₂CH₂CH₂CH₂]_{b}— or —[OCH(CH₃)CH₂]_{b}—, where b is as defined above, preferably a number from 3 to 10, or a group of formula —[O(CH₂)_{c}CO]_{b}— or —[O(CH₂)_{c}CO]_{(b-1)}—[O(CHR¹⁶CHR¹⁷)ₐ]—, where b is a number from 4 to 5 and b is as defined above, preferably a number from 3 to 10. Still more preferably, b is a number from 3 to 6.

It is preferred that the compounds are of a generally polymeric nature. The polymeric nature may be provided by either the group represented by Q or the group represented by A or by both.

The polyhydroxy residue of formula Q-(A-)ₘ, which may be polymeric and which forms the core of the compounds of the present invention has a major influence on the behaviour of the compounds. It is preferred that it should have a polymeric nature, since the resulting compounds tend to be liquid or of low melting point, thus aiding dispersion in the coating composition. Compounds having a similar structure but not polymeric tend to be solid and/or less soluble in these coating compositions. However, we prefer that the core residue, of formula Q-(A-)ₘ, should not have too high a molecular weight, and prefer that the residue of formula Q-(A-)ₘ should have a molecular weight no greater than 2000, preferably no greater than 1200, still more preferably no greater than 1000, and most preferably no greater than 800.

We particularly prefer that Q should be a residue of ethylene glycol, propylene glycol, butylene glycol, glycerol, trimethylolpropane, di-trimethylolpropane, pentaerythritol or di-pentaerythritol.

Alternatively, A may represent a direct bond, in which case, the residue Q is attached directly to the carbonylmethoxy group at the 2-position of the thioxanthone ring system. In this case, Q is preferably a residue of an alkanediol. The nature of the alkanediol is not critical to the invention, although relatively longer chain compounds are preferred. However, in general, the alkanediol may be a straight or branched chain compound having from 2 to 30 carbon atoms, for example, ethylene glycol, propylene glycol, butylene glycol (preferably 1,3-, 1,4- or 2,3-), pentanediol, hexanediol, octanediol, nonanediol, decanediol, dodecanediol, tridecanediol, tetradecanediol, pentadecanediol, hexadecanediol, heptadecanediol, octadecanediol, nonadecanediol, icosanediol, henicosanediol, docosanediol, icosanediol or triacosanediol, of which hexanediol and decanediol are preferred.

It will be appreciated that, when the compounds of the present invention are analysed, the numbers a, b and c in the above formulae need not be integral, and, indeed, it is unlikely that they will be integral, since the compounds of the present invention may be mixtures of several compounds in which the numbers a, b and c differ. In accordance with the present invention, provided that the average value of each of these numbers is as defined above, this will be satisfactory. Of course, for each individual molecule of the compounds of the present invention, a, b and c will be integral, and it might be possible to separate out such individual compounds, but, in practice, mixtures of these compounds are used.

X⁻ represents an anion. In general, there is no particular limitation on the nature of the anion to be used. However, where the compounds of the present invention are to be used as photoinitiators, the anion should be non-nucleophilic, or essentially non-nucleophilic, as is well known in the art. It should also be relatively bulky. If the compounds are not to be used as photoinitiators, the anion need not meet these requirements. For example, in some cases, it may be desirable not to store the compound in the form of the salt which is ultimately to be used. In that case, it may be preferable to form another salt, and then convert the compound to the desired salt at or close to the point of use. In such a case, it is not necessary that the anion should be non-nucleophilic.

Examples of non-nucleophilic anions are well known to those skilled in the art, and include anions of formula MZₙ⁻ where M represents a phosphorus, boron, antimony, arsenic, chlorine or carbon atom, Z represents a halogen atom except where M represents a halogen atom, an oxygen atom or a sulphite group, and n is an integer dependent upon the valence of M and Z. Preferred examples of such groups include the PF6⁻, SbF₆⁻, AsF₆⁻, BF₄⁻, B(C₆F₅)₄⁻, R^{a}B(Ph)₃⁻ (where R^{a} represents an alkyl group having from 1 to 6 carbon atoms and Ph represents a phenyl group), R^{b}SO₃⁻ (where R^{b} represents an alkyl or haloalkyl group having from 1 to 6 carbon atoms or an aryl group), ClO₄⁻ and ArSO₃⁻ (where Ar represents an aryl group) groups, of which the PF₆⁻, SbF₆⁻, AsF₆⁻, CF₃SO₃⁻ and BF₄⁻ groups are preferred and the PF₆⁻ group is most preferred.

Where the compounds of the present invention contain a carboxy group, i.e. where R⁷, R⁸, R⁹ or R¹⁰ represents a carboxy or carboxyalkoxy group, the resulting compounds may form esters, and these esters also form a part of the present invention. There is no particular limitation on the nature of the ester, other than those constraints well known to those skilled in the art, and preferred examples of esters include the alkyl esters, particularly those having from 1 to 12 carbon atoms, such as those containing the C₁-C₁₂ alkyl groups, and those derived from a polyalkylene glycol ether ester (especially the C₁-C₄ alkyl ethers), such as esters containing groups of formula:

—[OR²⁴]ₜOR²⁵

where R²⁴ represents an alkylene group having from 1 to 8 carbon atoms, R²⁵ represents an alkyl group having from 1 to 4 carbon atoms, and t is a number from 2 to 20, preferably from 5 to 10. More preferred are groups of formula:

—[OCH₂CHR²⁶]ₜOR²⁵

where R²⁵ and t are as defined above and R²⁶ represents an alkyl group having from 1 to 4 carbon atoms.

Where R¹¹, R¹², R¹³ or R¹⁴ represents a hydroxy group, the resulting compounds may also form esters with acids. Examples of such esters are given in “Protective Groups in Organic Synthesis” by T. W. Greene and P. G. M. Wuts, Second Edition, 1991, published by John Wiley & Sons, Inc.

Any combination of the preferred substituent groups and atoms listed above in respect of the substituents defined by R^{x} is also envisaged by the present invention.

We particularly prefer that the oxetane compound should be bis[(1-ethyl-3-oxetanyl)methyl]ether and that the thioxanthonium salt should be 10-biphenyl-4-yl-2-isopropyl-9-oxo-9H-thioxanthen-10-ium hexafluorophosphate.

The composition of the present invention may be formulated as a printing ink, varnish, adhesive or any other coating composition which is intended to be cured by energy, which may be supplied by irradiation, whether by ultraviolet or electron beam. Such compositions will normally contain at least a polymerisable monomer, prepolymer or oligomer, and a cationic photoinitiator, but may also include other components well known to those skilled in the art, for example, reactive diluents and, in the case of printing inks, a pigment. However, the composition is preferably formulated as a flexographic printing ink.

If desired, the whole of the polymerisable component of the curable composition may be supplied by the oxetane compound (a). However, a wide variety of other monomers and prepolymers may be subjected to cationic photoinitiation using the thioxanthonium compounds of the present invention as photoinitiators, and, if desired, such other monomers and prepolymers may be employed in addition to the oxetane compounds (a) of the present invention. Such other monomers and prepolymers typically contain cationically polymerisable groups, and general examples of such compounds include the epoxides, mono-functional oxetanes, other cyclic ethers, vinyl compounds (such as vinyl and propenyl ethers, styrene and its derivatives and unsaturated polyesters), unsaturated hydrocarbons, lactones and, in the case of hybrid systems, acrylates and methacrylates.

Typical epoxides which may be used include the cycloaliphatic epoxides (such as that sold under the designation Cyracure UVR6110 by Dow), which are well known to those skilled in the art.

Other epoxy-functional oligomers/monomers which may be used include the glycidyl ethers of polyols [bisphenol A, alkyl diols or poly(alkylene oxides), which be di-, tri-, tetra- or hexa-functional]. Also, epoxides derived by the epoxidation of unsaturated materials may also be used (e.g. epoxidised soybean oil, epoxidised polybutadiene or epoxidised alkenes). Naturally occurring epoxides may also be used, including the crop oil collected from Vemonia galamensis.

As well as epoxides, other reactive monomers/oligomers which may be used include the vinyl ethers of polyols [such as triethylene glycol divinyl ether, 1,4-cyclohexane dimethanol divinyl ether and the vinyl ethers of poly(alkylene oxides)]. Examples of vinyl ether functional prepolymers include the urethane-based products supplied by Allied Signal. Similarly, monomers/oligomers containing propenyl ether groups may be used in place of the corresponding compounds referred to above containing vinyl ether groups.

Similarly, compounds bearing a single oxetane group may be used. A typical oxetane is trimethylolpropane (3-ethyl-3-hydroxymethyloxetane).

Other reactive species can include styrene derivatives and cyclic esters (such as lactones and their derivatives).

It is also common to include polyols in ultraviolet cationic curable formulations, which promote the cross-linking by a chain-transfer process. Examples of polyols include the ethoxylated/propoxylated derivatives of, for example, trimethylolpropane, pentaerythritol, di-trimethylolpropane, di-pentaerythritol and sorbitan esters, as well as more conventional poly(ethylene oxide)s and poly(propylene oxide)s. Other polyols well known to those skilled in the art are the polycaprolactone diols, triols and tetraols, such as those supplied by Dow.

Additives which may be used in conjunction with the principal components of the coating formulations of the present invention include stabilisers, plasticisers, pigments, waxes, slip aids, levelling aids, adhesion promoters, surfactants and fillers.

The amounts of the various components of the curable composition of the present invention may vary over a wide range and, in general, are not critical to the present invention. However, we prefer that the amount of the oxetane compound (a) should be from 5 to 98.5% by weight, and more preferably from 15 to 60% by weight. We also prefer that said initiator comprising the thioxanthonium salt should be present in an amount of from 1.0 to 10% by weight, more preferably from 2.0 to 8%.

We particularly prefer that the composition should comprise from 5 to 98.5% by weight of said compound having at least two polymerisable oxetane groups and from 1.0 to 10% of said initiator comprising a thioxanthonium salt, more preferably from 15 to 60% by weight of said compound having at least two polymerisable oxetane groups and from 2.0 to 8% of said initiator comprising a thioxanthonium salt.

Other components of the curable composition may be included in amounts well known to those skilled in the art.

The curable compositions of this invention may be suitable for applications that include protective, decorative and insulating coatings; potting compounds; sealants; adhesives; photoresists; textile coatings; and laminates. The compositions may be applied to a variety of substrates, e.g., metal, rubber, plastic, wood, moulded parts, films, paper, glass cloth, concrete, and ceramic. The curable compositions of this invention are particularly useful as inks for use in a variety of printing processes, including, but not limited to, flexography, inkjet and gravure. Details of such printing processes and of the properties of inks needed for them are well known and may be found, for example, in The Printing Ink Manual, 5^{th} Edition, edited by R. H. Leach et al., published in 1993 by Blueprint, the disclosure of which is incorporated herein by reference.

Where the compositions of the present invention are used for inks, these typically comprise, as additional components to those referred to above, one or more of pigments, waxes, stabilisers, and flow aids, for example as described in “The Printing Ink Manual”.

The invention is further illustrated by the following non-limiting Examples.

### EXAMPLE 1

### Example of White Ink

The components shown in the following Table 1 were mixed in a conventional way to produce a white ink.

TABLE 1

| Description | Tradename | Supplier | Percentage |
|---|---|---|---|
| Propylene Carbonate | — | — | 4.50 |
| Bis[(1-ethyl-3- | OXT221 | Toagosei | 12.00 |
| oxetanyl)methyl]ether | | | |
| Titanium Dioxide Pigment | RDI | Finntitan | 43.00 |
| | SPECIAL | | |
| Pigment Dispersant | SOLSPERSE | Avecia | 1.00 |
| | 32000 | | |
| Wax | MPP 620 | Micro | 2.00 |
| | XXF | powders | |
| Cycloaliphatic di-epoxide | CYRACURE | Union | 33.00 |
| | UVR-6105 | carbide | |
| Cationic | Omnicat | IGM | 3.60 |
| Photoinitiator, 10- | 550 | | |
| biphenyl-4-yl-2- | | | |
| isopropyl-9-oxo- | | | |
| 9H-thioxanthen-10-ium | | | |
| hexafluorophosphate | | | |
| Acrylated Silicone Slip | EBECRYL | Ucb | 0.70 |
| Additive | 1360 | | |
| Defoamer | TEGO | Tego | 0.20 |
| | AIREX 920 | | |
| | | | 100.00 |

Laboratory benchmarking showed this ink to have higher opacity, lower viscosity and higher cross-link density when compared against existing cationic UV flexo technology. It also gave little odour during cure, compared to significant odour from existing technology.

Press trials have confirmed these results, running at 130 m/m on a MPS 10 unit in-line UV flexo press with 400 wpi lamps. No detectable odour was present at the point of cure or on print after curing. Competitive whites were reported at rumling at no more than 70 m/m with strong odour produced during cure. 200 m/m was the maximum speed of the press.

During a further press trial on a BHS in-line press with 600 wpi lamps, the ink achieved 200 m/m with no detectable odour.

### EXAMPLE 2

### Process Yellow Ink

The components shown in the following Table 2 were mixed in a conventional way to produce a yellow ink.

TABLE 2

| Description | Tradename | Supplier | Percentage |
|---|---|---|---|
| Yellow 126 Pigment | PERMANENT | Clariant | 14.600 |
| | YELLOW DGR | | |
| Yellow Dispersant | SOLSPERSE | Avecia | 0.949 |
| Synergist | 22000 | | |
| Pigment Dispersant | SOLSPERSE | Avecia | 2.920 |
| | 32000 | | |
| Cycloaliphatic | CYRACURE UVR- | Union | 46.970 |
| di-epoxide | 6105 | carbide | |
| Cationic | Omnicat 550 | IGM | 5.400 |
| Photoinitiator | | | |
| Propylene Carbonate | — | — | 6.750 |
| Bis[(1-ethyl-3- | OXT221 | Toagosei | 22.411 |
| oxetanyl)methyl]ether | | | |
| | | | 100.000 |

### EXAMPLE 3

### Process Magenta Ink

The components shown in the following Table 3 were mixed in a conventional way to produce a magenta ink.

TABLE 3

| Description | Tradename | Supplier | Percentage |
|---|---|---|---|
| Red 57.1 Pigment | IRGALITE | Ciba | 14.600 |
| | RUBINE 4BV | | |
| Pigment Dispersant | SOLSPERSE | Avecia | 1.460 |
| | 32000 | | |
| Cycloaliphatic di-epoxide | CYRACURE | Union | 49.379 |
| | UVR-6105 | carbide | |
| Cationic Photoinitiator | Omnicat | IGM | 5.400 |
| | 550 | | |
| Propylene Carbonate | — | — | 6.750 |
| Bis[(1-ethyl-3- | OXT221 | Toagosei | 22.411 |
| oxetanyl)methyl]ether | | | |
| | | | 100.000 |

### EXAMPLE 4

### Process Cyan Ink

The components shown in the following Table 4 were mixed in a conventional way to produce a cyan ink.

TABLE 4

| Description | Tradename | Supplier | Percentage |
|---|---|---|---|
| Blue 15.4 Pigment | SUNFAST | Sun | 14.025 |
| | BLUE | pigments | |
| | 249 3054 | | |
| Cycloaliphatic di-epoxide | CYRACURE | Union | 51.700 |
| | UVR-6105 | carbide | |
| Cationic Photoinitiator | Omnicat | IGM | 5.000 |
| | 550 | | |
| Propylene Carbonate | — | — | 6.250 |
| Bis[(1-ethyl-3- | OXT221 | Toagosei | 23.025 |
| oxetanyl)methyl]ether | | | |
| | | | 100.000 |

### EXAMPLE 5

### Process Black Ink

The components shown in the following Table 4 were mixed in a conventional way to produce a black ink.

TABLE 5

| Description | Tradename | Supplier | Percentage |
|---|---|---|---|
| Blue 15.4 Pigment | SUNFAST | Sun | 1.350 |
| | BLUE | pigments | |
| | 249 3054 | | |
| Black 7 Pigment | SPECIAL | Degussa | 12.900 |
| | BLACK | | |
| | 250 FLUFFY | | |
| Pigment Dispersant | SOLSPERSE | Avecia | 2.250 |
| | 32000 | | |
| Cycloaliphatic di-epoxide | CYRACURE | Union | 49.225 |
| | UVR-6105 | carbide | |
| Cationic Photoinitiator | Omnicat | IGM | 5.000 |
| | 550 | | |
| Propylene Carbonate | — | — | 6.250 |
| Bis[1-ethyl-3- | OXT221 | Toagosei | 23.025 |
| oxetanyl)methyl]ether | | | |
| | | | 100.000 |

Laboratory benchmarking has shown these process inks to have a higher cross-link density and significantly lower odour during cure than existing cationic UV flexo technology.

Press trials have confirmed these results. Yellow, magenta and cyan printed at up to 260 m/m on a Timsons in-line press with 550 wpi lamps, whilst reports suggested that competitive products have not achieved press speeds of greater than 100 m/m. 260 m/m was the maximum speed achievable by the press.

A trial on a MPS 10 unit in-line UV flexo press with 400 wpi lamps showed all 4 process colours to achieve 150 m/m. No detectable odour was present at the point of cure or on print after curing. Competitive products were reported at running at no more than 70 m/m with strong odour produced during cure. 150 m/m was the maximum capability of the press with its reverse-angle doctor blade.

A further trial on a BHS press with 600 wpi lamps, the ink achieved 200 m/m with no detectable odour. 200 m/m was the maximum speed of the press.

### EXAMPLE 6

### Comparison of 3-ethyl-3-hydroxymethyl-oxetane and Bis[(1-ethyl-3-oxetanyl)methyl]ether in varnish formulations

The effects of 3-ethyl-3-hydroxymethyl-oxetane (TMPO) and bis[(1-ethyl-3-oxetanyl)methyl]ether (di-TMPO) in varnish formulations on cure speed were compared. All formulations tested contained, by weight, 2% of Omnicat 550 photoinitiator (ex IGM), 1% of propylene carbonate, and 0.1% of Tegorad 2100 (wetting aid). The balance of the formulation was made up with varying proportions of TMPO or di-TMPO and a cycloaliphatic di-epoxide. Table 6 below shows these relative proportions and the results of solvent resistance tests using methyl ethyl ketone (MEK).

TABLE 6

| Varnishes with TMPO | | | | Varnishes with di-TMPO | | | |
|---|---|---|---|---|---|---|---|
| | | Time | | | | Time | |
| UVR6105¹⁾ | TMPO²⁾ | (minutes) | MEK³⁾ | UVR6105¹⁾ | Di-TMPO⁴⁾ | (minutes) | MEK³⁾ |
| 60 | 0 | 1 | 6 | 60 | 0 | 1 | 6 |
| 50 | 10 | 1 | 7 | 50 | 10 | 1 | 6 |
| 40 | 20 | 1 | 7 | 40 | 20 | 1 | 7 |
| 30 | 30 | 1 | 5 | 30 | 30 | 1 | 8 |
| 20 | 40 | 1 | 5 | 20 | 40 | 1 | 9 |
| 10 | 50 | 1 | 5 | 10 | 50 | 1 | 9 |
| 0 | 60 | 1 | 4 | 0 | 60 | 1 | 12 |
| 50 | 10 | 5 | 10 | 50 | 10 | 5 | 10 |
| 40 | 20 | 5 | 14 | 40 | 20 | 5 | 18 |
| 30 | 30 | 5 | 14 | 30 | 30 | 5 | 18 |
| 20 | 40 | 5 | 8 | 20 | 40 | 5 | 40 |
| 10 | 50 | 5 | 6 | 10 | 50 | 5 | >50 |
| 0 | 60 | 5 | 5 | 0 | 60 | 5 | >50 |
| 50 | 10 | 15 | 13 | 50 | 10 | 15 | 20 |
| 40 | 20 | 15 | 14 | 40 | 20 | 15 | 25 |
| 30 | 30 | 15 | 20 | 30 | 30 | 15 | 46 |
| 20 | 40 | 15 | 12 | 20 | 40 | 15 | >50 |
| 10 | 50 | 15 | 7 | 10 | 50 | 15 | >50 |
| 0 | 60 | 15 | 4 | 0 | 60 | 15 | >50 |
| 50 | 10 | 30 | 18 | 50 | 10 | 30 | 27 |
| 40 | 20 | 30 | 25 | 40 | 20 | 30 | 31 |
| 30 | 30 | 30 | 23 | 30 | 30 | 30 | >50 |
| 20 | 40 | 30 | 13 | 20 | 40 | 30 | >50 |
| 10 | 50 | 30 | 8 | 10 | 50 | 30 | >50 |
| 0 | 60 | 30 | 5 | 0 | 60 | 30 | >50 |
| 50 | 10 | 60 | 29 | 50 | 10 | 60 | 45 |
| 40 | 20 | 60 | 40 | 40 | 20 | 60 | 46 |
| 30 | 30 | 60 | 35 | 30 | 30 | 60 | >50 |
| 20 | 40 | 60 | 19 | 20 | 40 | 60 | >50 |
| 10 | 50 | 60 | 8 | 10 | 50 | 60 | >50 |
| 0 | 60 | 60 | 5 | 0 | 60 | 60 | >50 |

¹⁾Cycloaliphatic di-epoxide (Cyracure UVR 6105 ex Union Carbide)
²⁾3-ethyl-3-hydroxymethyloxetane (OXT101ex Toagosei Co., Ltd)
³⁾Number of rubs using methyl ethyl ketone
⁴⁾Bis[(1-ethyl-3-oxetanyl)methyl]ether (OXT221ex Toagosei Co., Ltd)

The varnishes were printed onto Lenetta charts with a No. 1 K bar and cured at 100 m/min using one 300 W/inch medium pressure mercury lamp operating at half power. The solvent resistance of the cured varnishes was measured by the number of double rubs using a cotton ball soaked in methyl ethyl ketone solvent before damage to the print became noticeable. The rubs were done at various time intervals after curing (show in minutes in the table). The higher the number of rubs, the greater the solvent resistance and the better the cure speed.

It can be seen from these results that varnishes containing di-TMPO have a significantly improved cure speed over those containing TMPO.

### EXAMPLE 7

Varnish formulations were prepared based on

| | |
|---|---|
| S-biphenyl isopropyl thioxanthonium | 2% |
| hexafluorophosphate (Omnicat 550 ex IGM) | |
| Propylene carbonate | 2.5% |
| Tegorad 2100 wetting aid ex TEGO | 0.1% |
| Oxetanes shown in Table 7 | 20% |
| UVR6105 cycloaliphatic epoxide ex DOW | 75.4% |

A similar formulation was prepared but with no oxetane and an additional 20% epoxide. All formulations were printed onto Lenetta charts using a No. 1 K bar and cured under a 300 W/inch medium pressure mercury arc lamp at 100 m/minute. The isopropanol (IPA) solvent resistance of the cured films was assessed immediately and after 1 hour using the SATRA STM 421 rub tester and the results are shown in Table 7.

TABLE 7

| | |
|---|---|
| Oxetane | IPA double rubs |

| Example | functionality | Immediate | 1 hour |
|---|---|---|---|
| No oxetane | — | 26 | 97 |
| TMPO | 1 | 29 | 114 |
| OXT 212 | 1 | 22 | 65 |
| OXT 221 | 2 | 68 | >250 |
| OXT 121 | 2 | 42 | 207 |
| PNOX | >2 | 66 | 242 |
| Methyl silicon trioxetane | 3 | 58 | 202 |

TMPO is 3-ethyl-3-hydroxymethyl-oxetane ex Perstorp
OXT 212 is 3-ethyl-3-[2-ethylhexyloxy)methyl]oxetane ex Toagosei
OXT 221 is bis[1-ethyl(3-oxetanyl)]methyl ether ex Toagosei
OXT 121 is [1,4-Bis(3-ethyl-3-oxetanylmethoxy)methyl]benzene ex Toagosei
PNOX is an oxetane functional novolac polymer ex Toagosei

These results demonstrate that the solvent resistance properties of cationic cured coatings containing multifunctional oxetane compounds is considerably improved over coatings containing no oxetane or only monofunctional oxetanes.

1. A cationically curable coating composition comprising:
(a) a cationically polymerisable component comprising at least one compound having at least two polymerisable oxetane groups and
(b) an initiator comprising a thioxanthonium salt.

2. A composition according to claim 1, in which said polymerisable component (a) is a compound of formula (I): 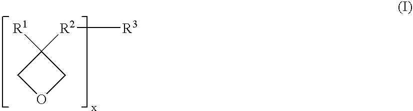
in which:
R¹ represents a hydrogen atom, a C₁-C₆ alkyl group, an aryl group or an aralkyl group;
R² represents a direct bond or a C₁-C₆ alkylene group;
R³ represents the residue of a polyol; and
x is a number from 2 to 6.

3. A composition according to claim 2, in which x is 2.

4. A composition according to claim 1, in which the polymerisable component (a) is a compound of formula (II): 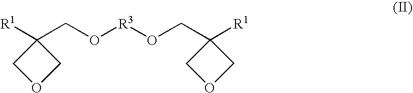
in which:
R¹ represents a hydrogen atom, a C₁-C₆ alkyl group, an aryl group or an aralkyl group, and the two groups R¹ may be the same as or different from each other; and
R³ represents a C₁-C₁₂ alkylene group, a C₁-C₁₂ alkenylene group, a poly(alkyleneoxy) group, a carbonyl group, a C₁-C₁₂ alkylene group in which a methylene group is replaced by a carbonyl group, an aryl group.

5. A composition according to claim 4, in which R³ represents a C₁-C₆ alkylene group.

6. A composition according to claim 1, in which the polymerisable component (a) is a compound of formula (III): 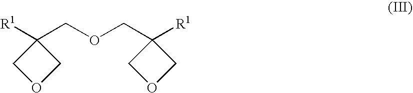
in which R¹ represents a hydrogen atom, a C₁-C₆ alkyl group, an aryl group or an aralkyl group, and the two groups R¹ may be the same as or different from each other.

7. A composition according to claim 6, in which the polymerisable component (a) is bis[(1-ethyl-3-oxetanyl)methyl]ether.

8. A composition according to claim 1, in which the polymerisable component (a) is compound of formula (IV): 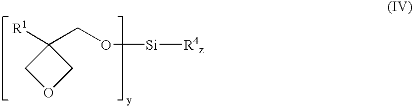
R¹ represents a hydrogen atom, a C₁-C₆ alkyl group, an aryl group or an aralkyl group;
R⁴ represents a group of formula —O—R⁵ or a group R⁶,
R⁵ represents a C₁-C₂₀ alkyl group, a C₂-C₂₀ alkenyl group, an aryl group, an aralkyl group, a polyalkylene oxide group or a poly(lactone) group;
R⁶ represents a C₁-C₂₀ alkyl group, an aryl group or an aralkyl group;
y is a number greater than 1 and no greater than 4; and
(y+z)=4.

9. A composition according to claim 8, in which the polymerisable component (a) is compound of formula (V): 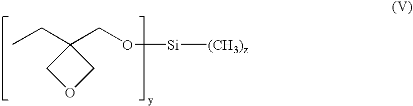
where y is a number of at least 2 and no greater than 4 and z is (4-y).

10. A composition according to claim 1, in which said thioxanthonium salt (b) is a compound of formula (VI): 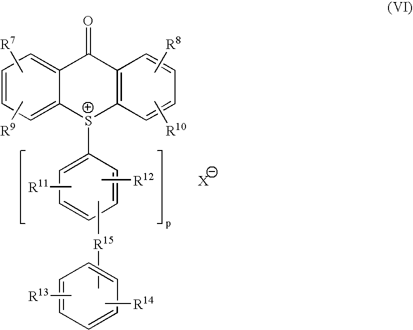
in which:
R⁷, R⁸, R⁹ and R¹⁰ are individually the same or different and each represents a hydrogen atom; an alkyl group having from 1 to 20 carbon atoms, an alkoxy group having from 1 to 20 carbon atoms, an alkenyl group having from 2 to 20 carbon atoms, a halogen atom, a nitrile group, a hydroxyl group, an aryl group having from 6 to 10 carbon atoms, an aralkyl group having from 7 to 13 carbon atoms, an aryloxy group having from 6 to 10 carbon atoms, an aralkyloxy group having from 7 to 13 carbon atoms, an arylalkenyl group having from 8 to 12 carbon atoms, a cycloalkyl group having from 3 to 8 carbon atoms, a carboxy group, a carboxyalkoxy group having from 2 to 7 carbon atoms, an alkoxycarbonyl group having from 2 to 7 carbon atoms, an aryloxycarbonyl group having from 7 to 13 carbon atoms, an alkylcarbonyloxy group having from 2 to 7 carbon atoms, an alkanesulphonyl group having from 1 to 6 carbon atoms, an arenesulphonyl group having from 6 to 10 carbon atoms, an alkanoyl group having from 1 to 6 carbon atoms or an arylcarbonyl group having from 7 to 11 carbon atoms;
R¹¹, R¹², R¹³ and R¹⁴ are individually the same or different and each represents a hydrogen atom, a hydroxy group, or an alkyl group having from 1 to 4 carbon atoms;
or R¹² and R¹⁴ are joined to form a fused ring system with the benzene rings to which they are attached;
R¹⁵ represents a direct bond, an oxygen atom or a methylene group;
p is 0 or 1; and
X^{⊖} represents an anion;
or an ester thereof

11. A composition according to claim 1, in which said thioxanthonium salt (b) is a compound of formula (VII): 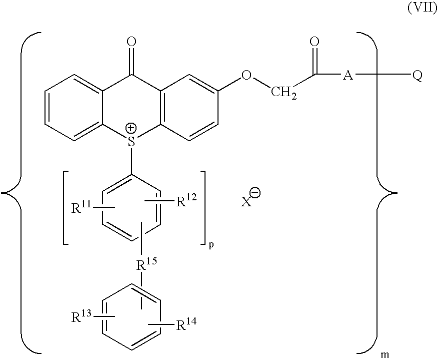
in which:
A represents a direct bond or a group of formula —[O(CHR¹⁶″CHR¹⁶)ₐ]_{b}—,
—[O(CH₂)_{c}CO]_{b}— or —[O(CH₂)_{c}CO]_{(b-1)}—[O(CHR¹⁶CHR¹⁷)ₐ]—, where:
one of R¹⁶ and R¹⁷ represents a hydrogen atom and the other represents a hydrogen atom or a methyl group;
a is a number from 1 to 2;
b is a number from 1 to 10;
c is a number from 4 to 5;
Q is a residue of a polyol having from 2 to 6 hydroxy groups;
m is a number greater than 1 but no greater than the number of available hydroxyl groups in Q;
R¹¹, R¹², R¹³ and R¹⁴ are individually the same or different and each represents a hydrogen atom, a hydroxy group, or an alkyl group having from 1 to 4 carbon atoms;
or R¹² and R¹⁴ are joined to form a fused ring system with the benzene rings to which they are attached;
R¹⁵ represents a direct bond, an oxygen atom or a methylene group;
p is 0 or 1; and
X^{⊖} represents an anion;
or an ester thereof.

12. A composition according to claim 1, in which said thioxanthonium salt (b) is a compound of formula (VIII): 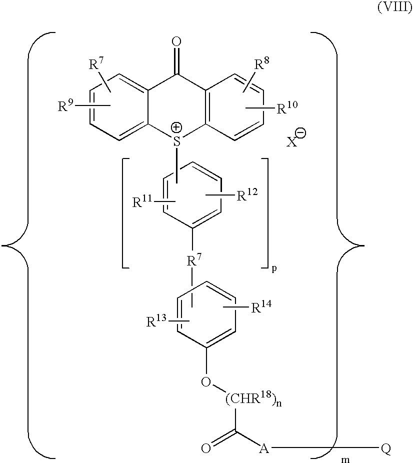
in which:
R⁷, R⁸, R⁹ and R¹⁰ are individually the same or different and each represents a hydrogen atom; an alkyl group having from 1 to 20 carbon atoms, an alkoxy group having from 1 to 20 carbon atoms, an alkenyl group having from 2 to 20 carbon atoms, a halogen atom, a nitrile group, a hydroxyl group, an aryl group having from 6 to 10 carbon atoms, an aralkyl group having from 7 to 13 carbon atoms, an aryloxy group having from 6 to 10 carbon atoms, an aralkyloxy group having from 7 to 13 carbon atoms, an arylalkenyl group having from 8 to 12 carbon atoms, a cycloalkyl group having from 3 to 8 carbon atoms, a carboxy group, a carboxyalkoxy group having from 2 to 7 carbon atoms, an alkoxycarbonyl group having from 2 to 7 carbon atoms, an
aryloxycarbonyl group having from 7 to 13 carbon atoms, an alkylcarbonyloxy group having from 2 to 7 carbon atoms, an alkanesulphonyl group having from 1 to 6 carbon atoms, an arenesulphonyl group having from 6 to 10 carbon atoms, an alkanoyl group having from 1 to 6 carbon atoms or an arylcarbonyl group having from 7 to 11 carbon atoms;
R¹¹, R¹², R¹³ and R¹⁴ are individually the same or different and each represents a hydrogen atom, a hydroxy group, or an alkyl group having from 1 to 4 carbon atoms;
or R¹² and R¹⁴ are joined to form a fused ring system with the benzene rings to which they are attached;
R¹⁵ represents a direct bond, an oxygen atom or a methylene group;
p is 0 or 1;
X^{⊖} represents an anion;
A represents a direct bond or a group of formula —[O(CHR¹⁶CHR¹⁷)ₐ]_{b}—,
—[O(CH₂)_{c}CO]_{b} or —[O(CH₂)_{c}CO]_{(b-1)}—[O(CHR¹⁶CHR⁷)ₐ]—, where:
one of R¹⁶ and R¹⁷ represents a hydrogen atom and the other represents a hydrogen atom or a methyl group;
a is a number from 1 to 2;
b is a number from 1 to 10;
c is a number from 4 to 5;
Q is a residue of a polyol having from 2 to 6 hydroxy groups;
m is a number greater than 1 but no greater than the number of available hydroxyl groups in Q;
n is a number from 1 to 12; and
R¹⁸ represents a hydrogen atom, a methyl group or an ethyl group, and, when n is greater than 1, the groups or atoms represented by R¹² may be the same as or different from each other;
or an ester thereof.

13. A composition according to claim 1, comprising from 5 to 98.5% by weight of said compound having at least two polymerisable oxetane groups and from 1.0 to 10% of said initiator comprising a thioxanthonium salt.

14. A composition according to claim 1, comprising from 15 to 60% by weight of said compound having at least two polymerisable oxetane groups and from 2.0 to 8% of said initiator comprising a thioxanthonium salt.

15. A composition according to claim 1, in which the compound (a) having at least two polymerisable oxetane groups is bis[(1-ethyl-3-oxetanyl)methyl]ether and the thioxanthonium salt (b) is 10-biphenyl-4-yl-2-isopropyl-9-oxo-9H-thioxanthen-10-ium hexafluorophosphate.

16. A composition according to claim 1, which contains a pigment and is a printing ink.

17. A composition according to claim 1, which is a varnish.

18. A composition according to claim 1, which is an adhesive.

19. A composition according to claim 1, formulated for flexographic printing.

20. A composition according to claim 1, formulated for inkjet printing.

21. A composition according to claim 1, formulated for gravure printing.

22. A process for preparing a cured coating composition, which comprises applying a composition according to any one of the preceding claims to a substrate and exposing the coated substrate to curing radiation sufficient to cure the coating.

23. A process according to claim 22, in which the curing radiation is ultraviolet.
